(19) United States
(12) Patent Application Publication
(10) Pub. No.: US 2006/0285084 A1
(43) Pub. Date: Dec. 21, 2006

(54) Light source module of a projector and color wheel thereof

(76) Inventor: Ying-Fang Lin, Taoyuan City (TW)

Correspondence Address: RABIN & Berdo, PC, 1101 14TH STREET, NW, SUITE 500, WASHINGTON, DC, 20005, US

(21) Appl. No.: 11/455,792

(22) Filed: Jun. 20, 2006

(30) Foreign Application Priority Data
Jun. 20, 2005 (TW) 94120502

(51) Int. Cl. G03B 21/14

(52) U.S. Cl. 353/84

(57) ABSTRACT

A light source module of a projector includes a first light source, a second light source, a light assembly and a color wheel. The first light source and the second light source are used for generating first light and second light. The light assembly includes a first light pipe, a second light pipe and a third light pipe. The first light pipe and the second light pipe are used for changing directions of the first light and the second light. The third light pipe is disposed near the first light pipe and the second light pipe, for integrating the first light and the second light and outputting third light. The color wheel has a center and includes color filtering areas symmetric to the center. The first light and the second light have the same color by passing through the symmetric color filtering areas.

This application claims the benefit of Taiwan application Serial No. 094120502, filed Jun. 20, 2005, the subject matter of which is incorporated herein by reference.

### BACKGROUND OF THE INVENTION

1. Field of the Invention

The invention relates in general to a light source module of a projector and a color wheel thereof, and more particularly to a light source module of a projector and a color wheel thereof being capable of overlapping light.

2. Description of the Related Art

Please referring to FIG. 1, a conventional projector is illustrated. The conventional projector 100 includes a light source 112, a reflector 113, a light pipe 134, a lens module 136, a fold mirror 138, an imaging device 142 and a lens 144.

The light source 112 is used for generating light. The reflector 113 is disposed on one side of the light source 112, for reflecting the light generated by the light source 112. As a result, the light is focused on one end of the light pipe 134. The light pipe 134 is used for receiving the focused light and then integrating it. The lens module 136 is used for receiving and focusing the light transmitted from the light pipe 134, and then transmitting the light toward the fold mirror 138. After reflected by the fold mirror 138, the light is transmitted to the imaging device 142. The imaging device 142 is used for receiving the light and generating an image accordingly. The lens 144 is used for receiving the image and then projecting the image to a screen 150.

In the conventional projector 100, the brightness and the uniformity of the light generated by the light source 112 are important factors in effecting the quality of image. When the light generated by the light source 112 is dark or non-uniform, the image projected by the projector 100 becomes unclear or dull. As a result, the projector 100 is unable to provide good vision for users. Therefore, how to increase the brightness and the uniformity of the light becomes an important issue.

### SUMMARY OF THE INVENTION

It is therefore an object of the invention to provide a light source module of a projector and a color wheel thereof, utilizing a light assembly to overlap the light generated by different light sources. As a result, the overlapped light is brighter and more uniform. A color wheel has a center and includes two first color filtering areas, two second color filtering areas and two third color filtering areas symmetric to the center. Therefore, after passing through the symmetric color filtering areas, the light generated by different light sources has the same color. When the brightness of different light sources is not the same, or when one of the light sources is broken, the light source module of the invention can still function normally.

The invention achieves the above-identified objects by providing a light source module of a projector including a first light source, a second light source and a light assembly. The first light source is used for generating first light. The second light source is used for generating second light. The light assembly includes a first light pipe, a second light pipe and a third light pipe. The first light pipe and the second light pipe are disposed near the first light source and the second light source respectively. And the first light pipe and the second light pipe are used for changing the directions of the first light and the second light respectively. The third light pipe is disposed near the first light pipe and the second light pipe, for integrating the first light and the second light and outputting third light accordingly. The third light is projected to an imaging device.

The invention achieves the above-identified objects by providing another light source module of a projector including a first light source, a second light source, a field lens and a color wheel. The first light source is used for generating first light. The second light source is used for generating second light. The field lens is disposed near the first light source and the second light source, for changing the directions of the first light and the second light. The field lens has a first focus and a second focus. The first focus is adjacent to the first light source, and the second focus is adjacent to the second light source. The color wheel is disposed on one side of the field lens opposite to the first light source and the second light source, and is disposed on the first focus and the second focus of the field lens, for filtering the color of the first light and the second light. After passing through the field lens and the color wheel orderly, the first light and the second light are overlapped to become a third light in front of an imaging device.

The invention achieves the above-identified objects by providing a color wheel having a center. The color wheel includes two first color filtering areas, two second color filtering areas and two third color filtering areas symmetric to the center respectively. First light and second light pass through the first color filtering areas, the second color filtering areas or the third color filtering areas respectively, so that the first light and the second light have the same color.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 illustrates a conventional projector.

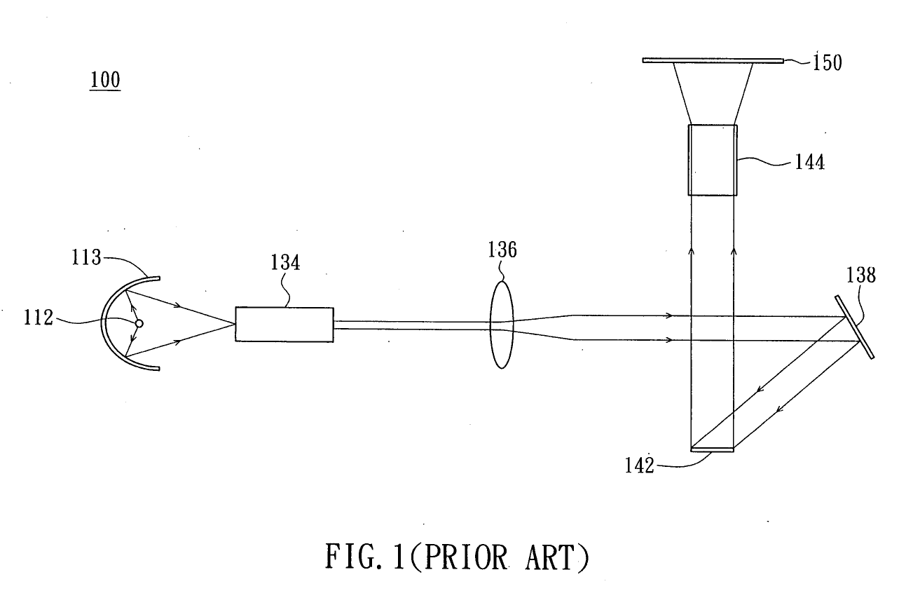

FIG. 2A illustrates a projector according to a first embodiment of the invention.

FIG. 2B illustrates the color wheel in FIG. 2A.

FIG. 3 illustrates a projector according to a second embodiment of the invention.

### DETAILED DESCRIPTION OF THE INVENTION

The invention utilizes a light assembly to overlap light generated by different light sources, to increase the brightness and uniformity of an image projected by a projector. A color wheel includes two first color filtering areas, two second color filtering areas and two third color filtering areas symmetric to a center of the color wheel respectively. As a result, the light generated by different light sources has the same color after passing through symmetric color filtering areas. Furthermore, when the brightness of different light sources is not the same, or when only one of the light sources is broken, the projector of the invention can still function normally.

A projector having two light sources is illustrated as follow. However, anyone who has ordinary skill in the field of the invention can understand that the invention is not limited to a projector having two light sources. The projector of the invention can be a projector having several light sources as well.

### First Embodiment

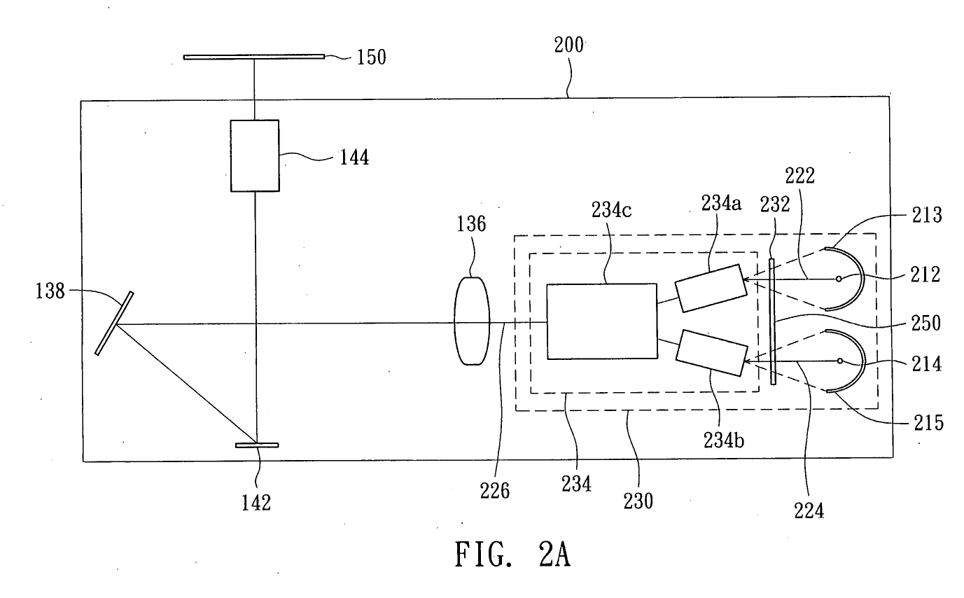

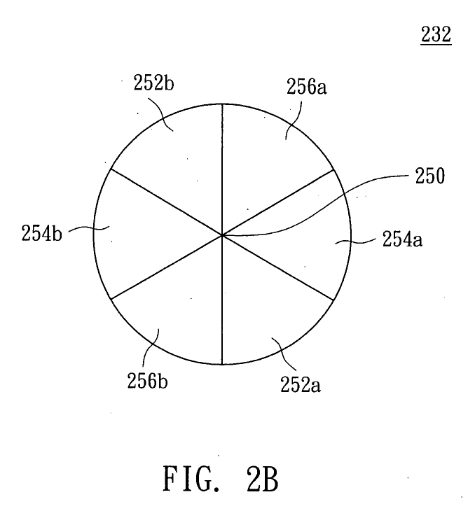

Please referring to FIG. 2A, a projector according to a first embodiment of the invention is illustrated. The projector 200 of the present embodiment of the invention includes a light source module 230 and an imaging device 142. The projector 200 preferably further includes a lens module 136, a fold mirror 138 and a lens 144.

The light source module 230 includes a first light source 212, a second light source 214 and a light assembly 234. The light source module 230 preferably further includes a first ellipse reflector 213, a second ellipse reflector 215 and a color wheel 232.

The first light source 212 is used for generating first light 222. For example, the first light source 212 is disposed on a first focal point of the first ellipse reflector 213. As a result, after reflected by the first ellipse reflector 213, the first light 222 is focused on a second focal point of the first ellipse reflector 213.

The second light source 214 is used for generating second light 224. For example, the second light source 214 is disposed on a first focal point of the second ellipse reflector 215. As a result, after reflected by the second ellipse reflector 215, the second light 224 is focused on a second focal point of the second ellipse reflector 215.

The color wheel 232 is preferably disposed between the first light source 212, the second light source 214 and the light assembly 234, for filtering the colors of the first light 222 and the second light 224. The color wheel 232 has a center 250 to be rotated about for filtering the colors of the first light 222 and the second light 224, wherein the first light source 212 and the second light source 214 are disposed at the same side of the color wheel 232 and respectively positioned at two sides of the center 250. Please referring to FIG. 2B, the color wheel 232 in FIG. 2A is illustrated. For example, the color wheel 232 preferably includes a first red light color filtering area 252a, a second red light color filtering area 252b, a first green light color filtering area 254a, a second green light color filtering area 254b, a first blue light color filtering area 256a and a second blue light color filtering area 256b. However, anyone who has ordinary skills in the field of the present embodiment of the invention can understand that the invention is not limited thereto. The color wheel of the invention can include color filtering areas in other colors.

The first red light color filtering area 252a and the second red light color filtering area 252b are symmetric to the center 250. The first green light color filtering area 254a and the second green light color filtering area 254b are symmetric to the center 250. The first blue light color filtering area 256a and the second blue light color filtering area 256b are symmetric to the center 250.

The color wheel 232 is preferably a circular disk. And the first red light color filtering area 252a, the second red light color filtering area 252b, the first green light color filtering area 254a, the second green light color filtering area 254b, the first blue light color filtering area 256a and the second blue light color filtering area 256b are preferably sectors. As a result, the color filtering areas are symmetric to the center 250.

The color wheel 232 rotates for controlling the color filtering areas which the first light and the second light pass through. When the color wheel 232 receives the first light and the second light, the first light and the second light pass through the color wheel 232 symmetrically to the center 250. Because the color filtering areas with the same color are symmetric to the center 250, the first light and the second light pass through the color filtering areas with the same color. Therefore, the first light and the second light have the same color after passing through the color wheel 232.

Please referring to FIG. 2A, after passing through the color wheel 232, the first light 222 and the second light 234 transmit to the light assembly 234. The light assembly 234 includes a first light pipe 234a, a second light pipe 234b and a third light pipe 234c. The first light pipe 234a is disposed near the first light source 212, for changing the direction of the first light 222. For example, one end of the first light pipe 234a is disposed on the second focal point of the first ellipse reflector 213. As a result, after reflected by the first ellipse reflector 213, the first light 222 is focused on the end of the first light pipe 234a where the end is on the second focal point of the first ellipse reflector 213.

The second light pipe 234b is disposed near the second light source 214, for changing the direction of the second light 224. For example, one end of the second light pipe 234b is disposed on a second focal point of the second ellipse reflector 215. As a result, after reflected by the second ellipse reflector 215, the second light 224 is focused on the end of the second light pipe 234b where the end is on the second focal point of the second ellipse reflector 215.

The third light pipe 234c is disposed near the first light pipe 234a and the second light pipe 234b, for integrating the first light 222 and the second light 224. After passing through the first light pipe 234a and the second light pipe 234b, the first light 222 and the second light 224 is overlapped by the third light pipe 234c to become third light 226.

The overlapped third light 226 passes through the lens module 136 and the fold mirror 138, and then is transmitted to the imaging device 142. For example, the imaging device 142 can be a digital micromirror device (DMD), for receiving the third light 226 and generating an image accordingly. The lens 144 is used for receiving the image and projecting the image to a screen 150.

### Second Embodiment

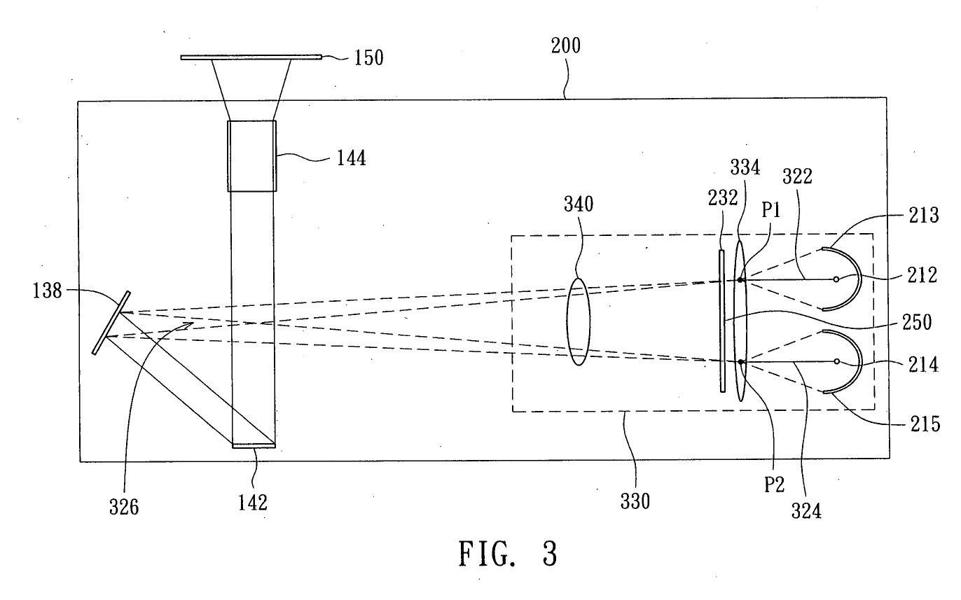

Please referring to FIG. 3, a projector according to a second embodiment of the invention is illustrated. The projector 300 of the present embodiment of the invention includes a light source module 330 and an imaging device 142. The projector 300 preferably further includes a fold mirror 138 and a lens 144.

The light source module 330 includes a first light source 212, a second light source 214, a field lens 334 and a color wheel 232. The light source module 330 preferably further includes a first ellipse reflector 213, a second ellipse reflector 215 and a relay lens 340.

The first light source 212 is used for generating first light 322. For example, the first light source 212 is disposed on a first focal point of the first ellipse reflector 213. As a result, after reflected by the first ellipse reflector 213, the first light 322 is focused on a second focal point of the first ellipse reflector 213.

The second light source 214 is used for generating second light 324. For example, the second light source 214 is disposed on a first focal point of the second ellipse reflector 215. As a result, after reflected by the second ellipse reflector 215, the second light 324 is focused on a second focal point of the second ellipse reflector 215.

The field lens 334 is disposed near the first light source 212 and the second light source 214, for changing the directions of the first light 322 and the second light 324. Therefore, the first light 322 and the second light 324 is overlapped to become third light 326 in front of the imaging device 142.

The field lens 334 has a first focus P1 and a second focus P2. For example, the first focus P1 of the field lens 334 is on the second focal point of the first ellipse reflector 213. As a result, the first light 322 is focused on the first focus P1 of the field lens 334 by the first ellipse reflector 213. For example, the second focus P2 of the field lens 334 is on the second focal point of the second ellipse reflector 215. As a result, the second light 324 is focused on the second focus P2 of the field lens 334 by the second ellipse reflector 215.

After passing through the first focus P1 and the second focus P2 of the field lens 334, the first light 322 and the second light 324 are transmitted to the color wheel 232. The color wheel 232 is preferably disposed on one side of the field lens 334 opposite to the first light source 212 and the second light source 214, for filtering the colors of the first light 322 and the second light 324. In the projector 300 of the present embodiment of the invention, the structure of the color wheel 232 is the same as those of the color wheel in the first embodiment of the invention. Therefore, the structure of the color wheel 232 is not described redundantly.

The relay lens 340 is disposed between the color wheel 232 and the imaging device 142, for receiving the filtered first light 322 and the filtered second light 324. However, anyone who has ordinary skills in the field of the present embodiment of the invention can understand that the relay lens 340 is not a necessary device of the invention. The relay lens 340 is only an optional technical means of the invention. The protected field of the invention is according to the claims as follow.

After passing through the relay lens 340, the first light 332 and the second light 334 is transmitted to fold mirror 138. The fold mirror 138 is used for reflecting light toward the imaging device 142. For example, the first light 322 and the second light 324 are overlapped to become third light 326 in front of the fold mirror 138. And the fold mirror 138 is used for reflecting the third light 326 toward the imaging device 142.

For example, the imaging device 142 can be a digital micromirror device (DMD), for receiving the third light 326 and generating an image accordingly. The lens 144 is used for receiving the image and projecting the image to a screen 150.

The projector of the above embodiments of the invention utilizes the light assembly to overlap the light generated by different light sources. The overlapped light is brighter and more uniform, so that the image projected by the projector is clearer and more vivid. The color wheel includes two first color filtering areas, two second color filtering areas and two third color filtering areas symmetric to the center of the color wheel. Therefore, the light generated by different light sources has the same color after passing through the symmetric color filtering areas. Furthermore, the light generated by different light sources is transmitted to the whole imaging device rather than a part of the imaging device. As a result, when the brightness of different light sources is different, or when only one of the light sources is broken, the projector can still project the complete image and function continuously. Therefore, the projector of the above embodiments of the invention can increase the brightness and uniformity of the light and has more flexibility in utilization.

While the invention has been described by way of example and in terms of embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A light source module of a projector, comprising:
a first light source for generating first light;
a second light source for generating second light; and
a color wheel having a center to be rotated about for filtering the first light and the second light, wherein the first light source and the second light source are disposed at the same side of the color wheel and respectively positioned at two sides of the center.

2. The module according to claim 1 further comprising:
a light assembly comprising:
a first light pipe disposed near the first light source for changing a direction of the first light;
a second light pipe disposed near the second light source for changing a direction of the second light; and
a third light pipe disposed near the first light pipe and the second light pipe for integrating the first light and the second light and outputting a third light, wherein the third light is projected to an imaging device;
wherein the first light and the second light are transmitted to the first light pipe and the second light pipe respectively after passing through the color wheel.

3. The module according to claim 2 further comprising:
a first ellipse reflector, wherein the first light source is disposed on a first focal point of the first ellipse reflector, and an end of the first light pipe is disposed on a second focal point of the first ellipse reflector; wherein the first light is focused on the end of the first light pipe after reflected by the first ellipse reflector; and
a second ellipse reflector, wherein the second light source is disposed on a first focal point of the second ellipse reflector, and one end of the second light pipe is disposed on a second focal point of the second ellipse reflector; wherein the second light is focused on the end of the second light pipe after reflected by the second ellipse reflector.

4. The module according to claim 1, wherein the color wheel comprises:
two first color filtering areas symmetric to the center;
two second color filtering areas symmetric to the center; and
two third color filtering areas symmetric to the center;
wherein the first light and the second light have the same color by passing through the two first color filtering areas, the two second color filtering areas or the two third color filtering areas respectively.

5. The module according to claim 4, wherein the color wheel is a circular disk, and the two first color filtering areas, the two second color filtering areas and the two third color filtering areas are sectors symmetric to the center.

6. A light source module of a projector comprising:
a first light source for generating first light;
a second light source for generating second light;
a field lens disposed near the first light source and the second light source for changing directions of the first light and the second light, wherein the field lens has a first focus and a second focus, the first focus is adjacent to the first light source, and the second focus is adjacent to the second light source; and
a color wheel disposed at the first focus and the second focus of the field lens, wherein the color wheel is disposed on a side of the field lens opposite to the first light source and the second light source, for filtering the first light and the second light;
wherein after passing through the field lens and the color wheel orderly, the first light and the second light are overlapped to become third light in front of an imaging device.

7. The module according to claim 6 further comprising:
a first ellipse reflector, wherein the first light source is disposed on a first focal point of the first ellipse reflector, and the first focus of the field lens is located on a second focal point of the first ellipse reflector; wherein the first light is focused on the first focus of the field lens after reflected by the first ellipse reflector; and
a second ellipse reflector, wherein the second light source is disposed on a first focal point of the second ellipse reflector, and the second focus of the field lens is located on a second focal point of the second ellipse reflector; wherein the second light is focused on the second focus of the field lens after reflected by the second ellipse reflector.

8. The module according to claim 6, wherein the color wheel has a center and comprises:
two first color filtering areas symmetric to the center;
two second color filtering areas symmetric to the center; and
two third color filtering areas symmetric to the center;
wherein the first light and the second light have the same color by passing through the two first color filtering areas, the two second color filtering areas, or the two third color filtering areas respectively.

9. The module according to claim 8, wherein the color wheel is a circular disk, and the two first color filtering areas, the two second color filtering areas and the two third color filtering areas are sectors symmetric to the center.

10. The module according to claim 6, wherein the imaging device is a digital micro-mirror device (DMD).

11. The module according to claim 6 further comprising a relay lens disposed between the color wheel and the imaging device.

12. A color wheel having a center and comprising:
two first color filtering areas symmetric to the center;
two second color filtering areas symmetric to the center; and
two third color filtering areas symmetric to the center;
wherein first light and second light have the same color by passing through the first color filtering areas, the second color filtering areas or the third color filtering areas respectively.

13. The color wheel according to claim 12, wherein the first color filtering areas are two red light color filtering areas, the second color filtering areas are two green light color filtering areas and the third color filtering areas are two blue light color filtering areas.

14. The color wheel according to claim 12 being disposed near a first light source and a second light source, for filtering the first light and the second light generated by the first light source and the second light source respectively, wherein the first light and the second light have the same color by passing through the first color filtering areas, the second color filtering areas or the third color filtering areas respectively.

15. The color wheel according to claim 12 being a circular disk, wherein the first color filtering areas, the second color filtering areas and the third color filtering areas are sectors symmetric to the center.
